(19) United States
(12) Patent Application Publication
(10) Pub. No.: US 2017/0321292 A1
(43) Pub. Date: Nov. 9, 2017

(54) COLD TREATMENT FOR IMPROVING THE LOAD-BEARING CAPACITY OF METALLIC COMPONENTS

(71) Applicants: ZF Friedrichshafen AG, Friedrichshafen (DE); ZF Wind Power Antwerpen N.V., Lommel (BE)

(72) Inventor: Dirk LEIMANN, Edegem (BE)

(21) Appl. No.: 15/527,342

(22) PCT Filed: Oct. 19, 2015
(86) PCT No.: PCT/EP2015/074095

§ 371 Date: May 17, 2017

(30) Foreign Application Priority Data
Nov. 17, 2014 (DE) 10 2014 223 399.2

(51) Int. Cl. C21D 1/19; C21D 9/40; C21D 9/38; C21D 9/36; C21D 9/32; C21D 6/04; C21D 1/78; F16C 33/64; C21D 1/63

(52) U.S. Cl. CPC C21D 1/19; F16C 33/64; C21D 9/40; C21D 9/38; C21D 1/63; C21D 9/32; C21D 6/04; C21D 1/78; C21D 9/36

(57) ABSTRACT

A method for producing a metallic component, The method includes the method steps of first machining (103) the component and thereafter cooling (105) the component from a first temperature down to a lower second temperature. The cooling (105) occurs after the machining (103) of the component.

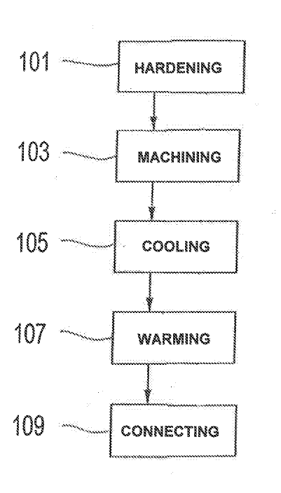

This application is a National Stage completion of PCT/EP2015/074095 filed Oct. 19, 2015, which claims priority from German patent application serial no. 10 2014 223 399.2 filed Nov. 17, 2014.

### FIELD OF THE INVENTION

The invention concerns a method for producing a metallic component.

### BACKGROUND OF INVENTION

From the document DE 102 09 264 B4 such a method is known, in which a metallic component is first machined and then heated. This heating concludes the production of the component.

The machining process produces a high dislocation density, Furthermore, crack-inhibiting, compressive internal stresses can be produced in an edge layer . The result of heating is that in the edge layer a fatigue-resistant structure becomes stabilized. However, during the heating undesired chemical reactions can take place, as the result of which the properties of the component deteriorate.

### SUMMARY OF THE INVENTION

The purpose of the present invention is to provide a method for producing a metallic component which overcomes the disadvantages inherent in the methods known from the prior art. In particular, the load-bearing capacity of the component is to be improved.

The method according to the invention comprises the following process steps:
machining of the component; and
cooling of the component from a first temperature to a second temperature.

The process step of cooling is carried out after the process step of machining.

Preferably, the process step of cooling is carried out immediately after the process step of machining. This means that between the machining and the cooling no other process step is carried out, in particular no further process step for producing the component.

The metallic component can be in particular a component consisting of steel.

The present invention is based on the knowledge that a fatigue-resistant structure can be stabilized in the edge layer not only by heating, but also by cooling.

When the component is cooled no undesired side effects of a chemical nature need be feared. Furthermore, compared with heating the process stability is improved. Thus, considerable effort is entailed in preventing deviations from a defined heating temperature. If heated too much the component can be damaged. On the other hand, if the heating is insufficient the desired stabilizing effect in the edge layer does not take place.

In contrast, the component can be cooled by immersing it in a liquid with a freezing point below the second temperature. Correspondingly, the boiling point of the liquid is above the second temperature. So long as the liquid is in a fluid condition, marked deviations from the second temperature are excluded in this way.

In a preferred further development of the method, the cooling of the component is the last process step for producing the component. Thus, after the cooling of the component there is no further process step which would constitute a process step for producing the component. All further steps constituting process steps for producing the component are correspondingly carried out before the component is cooled.

A process step for production is understood to mean a process step attributable to a production method. Production methods are defined in the Standard DIN 8580 and then enumerated.

Accordingly, a process step for producing a component can in a general sense be regarded as any process step that permanently changes at least one property of the component. In contrast, if the changes brought about in a component in a process step are only of a temporary nature, that does not count as a process step for producing the component.

Preferably the first temperature, starting from which the component is cooled to the second temperature, is room temperature. Room temperature is the temperature of a space in which the method according to the invention is carried out.

Correspondingly, the first temperature is preferably between 5° C. and 35° C., in particular between 15° C. and 30° C. or between 18° C. and 25° C.

Cooling is preferably carried out to a second temperature between −50° C. and −200° C. In particular, the second temperature can be between −70° C. and −196° C.

Dry ice or liquid air, for example, is suitable as the above-mentioned liquid. If dry ice is used the second temperature is between −70° C. and −79° C. If liquid air is used the second temperature is between −190° C. and −196° C.

To ensure that the effect to be produced by the cooling is in fact achieved, the component is preferably held in a condition cooled to the second temperature for a time of at least five minutes. Thus, the component remains at the second temperature for at least five minutes. In particular, the second temperature can be maintained for at least seven minutes, for at least ten minutes, for at least fifteen minutes, for at least twenty minutes, for at least twenty-five minutes, or if necessary even longer.

In a preferred further development, after the component has been cooled to the second temperature it is warmed again to the first temperature. This is preferably done by removing the component from the liquid and exposing it to room temperature.

Thereafter, the component made in accordance with the invention can be connected to a first further component, such as a shaft. For this, the component made according to the invention is preferably shrink-fitted onto the first further component and/or the first further component is cold-stretched onto the component made according to the invention. For shrink-fitting, the component made according to the invention is heated to a temperature above the first temperature. Correspondingly, for cold-stretching the first further component is cooled from the first temperature to a temperature below the first temperature.

In particular, the life of metallic components with dynamically loaded working surfaces is improved by applying the method according to the invention. Correspondingly, in a preferred further development the component made using the method according to the invention has at least a first working surface which can form a working surface pair with a second working surface of a second further component for the transmission of a force. For this, the first working surface and the second working surface roll on one another and/or slide against one another, There is direct contact between the two working surfaces. In particular, the component made according to the invention and the second further component are arranged so that they can move relative to one another,

The component made according to the invention and the second further component are preferably in each case a gearwheel, in particular a gearwheel with external teeth, or part of a bearing such as an inner race, an outer race or a rolling element.

After the process step of cooling, the gearwheel is preferably fitted onto a shaft, which could be the first further component. For this, the shaft is passed at least partially through the gearwheel. Thus, the gearwheel is arranged radially on the outside and the shaft radially on the inside.

In another preferred further development the process step of machining is preceded by a process step in which the component is hardened, for example by heating and quenching.

### BRIEF DESCRIPTION OF THE DRAWINGS

A preferred example embodiment of the method according to the invention is represented in the sole FIGURE, which shows in detail a flow chart of the inventive method.

### DETAILED DESCRIPTION OF THE DRAWING

The method illustrated in sole FIGURE comprises the following process steps:
hardening 101 of a metallic component;
machining 103 of the component;
cooling 105 of the component from a first temperature to a second temperature;
warming 107 of the component from the second temperature at least to the first temperature; and
connecting 109 the component to a further component.

### INDEXES

101 Hardening
103 Machining
105 Cooling
107 Warming
109 Connecting

1-11. (canceled)

12. A method for producing a metallic component, the method comprising the following:
machining (103) of the component; and
cooling (105) the component from a first temperature to a second temperature, with the cooling (105) takes place after the machining (103).

13. The method according to claim 12, further comprising defining the cooling (105) of the component as being a final method step such that no additional steps that constitute a method step for producing the component occur following the cooling of the component.

14. The method according to claim 12, further comprising defining the first temperature as being a temperature of a space in which the method is carried out.

15. The method according to claim 12, further comprising defining the first temperature as being between 5° C. and 35° C.

16. The method according to claim 12, further comprising defining the second temperature as being between −50° C. and −200° C.

17. The method according to claim 12, further comprising:
warming (107) the component from the second temperature at least up to the first temperature; and
connecting (109) the component to a first further component, with the connecting (109) step taking place after the warming (107) step.

18. The method according to claim 17, further comprising forming the connection (109) by at least one of shrink-fitting the component and cold-shrinking the first further component.

19. The method according to claim 12, further comprising the component has at least one working surface and a further second component has at least a second working surface, the first working surface and the second working surface can at least one of roll on and slide against one another in such manner that the first working surface forms together with the second working surface, a working surface pair for transmitting a force.

20. The method according to claim 19, further comprising defining the component as either a gearwheel or part of a bearing.

21. The method according to claim 20, further comprising fitting the gearwheel onto a shaft after the cooling (105).

22. The method according to claim 12, further comprising:
first hardening (101) the component; and
machining (103) the component after the hardening (101).

23. A method for producing a metallic component, the method comprising:
defining component producing process steps as being process steps that, when conducted on the metallic component, permanently change at least one property of the metallic component and defining non-component producing process steps as being process steps that, when conducted on the metallic component, only temporarily change at least one property of the metallic component;
conducting a hardening, component producing process step by heating and quenching the metallic component;
conducting a machining, component producing process step by which the metallic component is machined and during which the metallic component is at a first temperature;
conducting a cooling, component producing process step directly following the machining, component producing process step by immersing the metallic component in a liquid which is at a second temperature, that is lower than the first temperature, to cool the metallic component from the first temperature to the second temperature;
defining the cooling, component producing process step as a final, component producing process step to prevent further permanent changes of at least one property of the metallic component following cooling the metallic component from the first temperature to the second temperature;
conducting a warming, non-component producing process step to warm the metallic component back toward the first temperature by removing the metallic component from the liquid at the second temperature: and
permanently connecting the metallic component to another component.
